(19) United States
(12) Patent Application Publication
(10) Pub. No.: US 2015/0291309 A1
(43) Pub. Date: Oct. 15, 2015

(54) COLLAPSIBLE CONTAINER

(71) Applicant: Rob Roy McGregor, Toronto (CA)

(72) Inventor: Rob Roy McGregor, Toronto (CA)

(21) Appl. No.: 14/106,303

(22) Filed: Dec. 13, 2013

Related U.S. Application Data
(63) Continuation-in-part of application No. 12/758,092, filed on Apr. 12, 2010, now abandoned.

(51) Int. Cl. B65D 21/08; B65D 25/14; A47J 41/00; B65D 81/38; A47J 33/00; A47J 36/04

(52) U.S. Cl. CPC B65D 21/086; A47J 33/00; A47J 36/04; A47J 41/0055; B65D 81/3865; B65D 25/14

(57) ABSTRACT

The present invention is directed to a collapsible container which is movable from a collapsed position having a reduced volume for storage and transport and an expanded position having dimensional rigidity and securely holding the contents of the container. The collapsible container has a plurality of outer wall segments being movable from a collapsed position wherein the plurality of outer wall segments are stacked within each other such that the height of the collapsed container is similar to the height of the individual outer wall segments and an expanded position for use of the collapsible container. The outer wall segments are provided with releasable locking means whereby the outer wall segments may be locked one to another in the expanded position and being releasable to allow for the collapsible container to be moved to the collapsed position.

### CROSS REFERENCE TO RELATED APPLICATIONS

This application is a continuation-in-part of U.S. Ser. No. 12/758,092 filed Apr. 12, 2010.

### FIELD OF THE INVENTION

The present invention is directed to a collapsible container, and in particular a collapsible container which collapses easily in a cascading manner while maintaining dimensional ridigity.

### BACKGROUND OF THE INVENTION

Collapsible containers, particularly drinking containers have been known for a number of years. These containers are commonly used by hikers and campers where the collapsed container is easier to carry in a backpack, taking up less space than a traditional container. Examples of such containers are shown in U.S. Pat. Nos. 6,736,285, 6,666,329, 5,575,398, 6,484,897 and 7,048,317 among others.

U.S. Pat. No. 6,736,285 issued May 18, 2004 to Stewart-Stand describes a collapsible container such as a drinking cup which has a disk-shaped bottom and a disk-shaped cover which fit within one another and engage by catches. A molded inner cup body has its base connected to the bottom and a mouth surrounded by a ring which seals to the cover and springs up from the bottom to erect the cup when the catches are released. While the patent describes a collapsible drinking container, the container in the expanded configuration does not have dimensional rigidity in that the sidewalls have to easily collapse to allow the container to be placed in the collapsed orientation.

U.S. Pat. No. 6,666,329 issued Dec. 23, 2005, to Charbonneau describes a collapsible cup with a vented pocket having a base member for supporting the cup. A plurality of telescoping segments form a fluid-tight seal by friction fitting the plurality of telescoping segments together with the outermost telescoping segment being attached to the base member and the innermost segment being provided with a vented pocket. As the telescoping segments are only friction fitted, the cup has no dimensional rigidity and there is a risk of the cup collapsing during operation.

U.S. Pat. No. 5,575,398 issued Nov. 19, 1996 to Robbins describes reusable collapsible container having a bottom wall and a flexible peripheral side wall being movable between axially extended and collapsed positions. The side wall has upper and lower relatively thicker portions and an intermediate relatively thinner portion between the upper and lower portions. The intermediate side wall portion is tapered radially inwardly and downwardly, and the lower side wall portion is tapered radially outwardly and downwardly, such that in the collapsed position the lower side wall portion is partially telescoped within the upper side wall portion, and the intermediate portion is reverse folded therebetween.

U.S. Pat. No. 6,484,897, issued Nov. 26, 2002, to Crawley describes a container of variable volume having an inner flexible member enclosed in a number of interlocking outer sleeves. The outer sleeves are moved relative to one another to vary the volume of the container by rotating screw-threaded outer sleeves, ratchet mechanism or by using a multi-level bayonet type connection.

U.S. Pat. No. 7,048,317, issued May 23, 2006, to Netsch describes a collapsible scoop having a bellow section of a plurality of slant wall sections and thin wall sections between adjacent slant wall sections defining peaks and valleys between the adjacent slant wall sections. The thin wall sections allow the bellows to be moved between the collapsed and extended positions.

While the above patents describe a number of collapsible containers, there still remains a need for a collapsible container which has dimensional rigidity in the expanded position yet is easily collapsible into the collapsed position and provides for secure storage of the contents of the container in the expanded position.

### SUMMARY OF THE INVENTION

The present invention is directed to a collapsible container which is movable from a collapsed position having a reduced volume for storage and transport and an expanded position having dimensional rigidity and securely holding the contents of the container. The collapsible container comprises a plurality of outer wall segments having a side wall with a first and second edge, the outer well segments being movable from a collapsed position wherein the plurality of outer wall segments are stacked within each other such that the height of the collapsed container is similar to the height of the individual outer wall segments and an expanded position for use of the collapsible container. The outer wall segments are provided with releasable locking means whereby the outer wall segments may be locked one to another in the expanded position and being releasable to allow for, the collapsible container to be moved to the collapsed position. The releasable locking means comprises a releasable locking latch means adjacent a first edge of each of the outer well segments and a locking latch means receptacle adjacent a second edge of the outer wall segments, the releasable locking latch means of an outer wall segment cooperating with the releasable locking latch means receptacle of an adjacent outer wall segment to releasably lock the collapsible container in the expanded portion, the releasable locking latch means of an outer wall segment being disengageable from the releasable locking latch means receptacle of the adjacent outer wall segment to allow the collapsible container to be moved to the collapsed position.

In an aspect of the invention, the releasable locking latch means comprises a rib on a first surface of the outer wall segment and the releasable locking latch means receptacle comprises a groove to accept the rib and securely hold the rib in the groove.

In another aspect of the invention, the releasable locking latch means comprises a resilient tab formed in the side wall of the outer wall segment, the resilient tab having a lug extending from a first surface of the outer wall segment and the releasable locking latch means receptacle comprises an opening to accept the lug and securely hold the lug in the opening.

In yet another aspect of the invention, the collapsible container further comprises a fluid tight inner liner which is movable from a collapsed position to an expanded position along with the outer wall segments, the inner liner being attached to the outer wall segment at the top thereof.

In a further aspect of the invention, the inner liner comprises a plurality of inner liner segments, the number of inner wall segments being equal to the number of outer wall segments. The uppermost inner wall segment is attached to the uppermost outer wall segment and the lowermost inner wall segment is provided with a bottom at the lower end thereof contiguous with the wall of the inner liner segment. Each of the inner wall segments is joined to the adjacent inner wall segment by a living hinge to allow the inner wall segments to be moved between an expanded position to form a liquid tight liner for the collapsible container and a collapsed position wherein the inner liner segments pivot about the living hinges joining the adjacent inner wall segments such that in the collapsed position, the inner wall segments form a pleated arrangement.

In yet another aspect of the invention, the collapsible container comprises a removable cover which in a closed position seals the interior of the container and is releasable to allow access to the interior of the container.

In a further aspect of the invention, the collapsible container comprises a hole in the bottom of the inner liner, the hole being sealed by a pair of thermal conductive plates which sandwich the bottom of the inner liner to form a water-tight seal and act as a means of heating the liquid contents with the application of a heating source to the conductive plates.

### BRIEF DESCRIPTION OF THE DRAWINGS

Preferred embodiments of the present invention are illustrated in the attached drawings in which:

FIG. 1 is a perspective view of a first collapsible cup in accordance with the present invention in an expanded position;

FIG. 2 is a perspective view in cross section of the collapsible cup of FIG. 1;

FIG. 3 is a perspective view of the outer wall of the collapsible cup of FIG. 1 in the expanded position;

FIG. 4 is a perspective view in cross section of the outer wall of the collapsible cup of FIG. 4;

FIG. 5 is a perspective view of the outer wall of the collapsible cup of FIG. 1 in the collapsed position;

FIG. 6 is a perspective view in cross section of the outer wall of the collapsible cup of FIG. 5;

FIG. 7 is a perspective view of a second collapsible cup in accordance with the present invention in an expanded position;

FIG. 8 is a perspective view in cross section of the collapsible cup of FIG. 7;

FIG. 9 is a perspective view of the outer wall of the collapsible cup of FIG. 7 in the expanded position;

FIG. 10 is a perspective view of the outer wall of the collapsible cup of FIG. 7 in the expanded position illustrating the releasable locking mechanism;

FIG. 11 is a perspective view of the outer wall of the collapsible cup of FIG. 7 in the collapsed position;

FIG. 12 is a perspective view in cross section of the outer wall of the collapsible cup of FIG. 11;

FIG. 13 is a perspective view of a collapsible baby bottle in accordance with the present invention in an expanded position;

FIG. 14 is a perspective view in cross section of the collapsible baby bottle of FIG. 13 in the collapsed position;

FIG. 15 is a perspective view of the outer wall of the collapsible baby bottle of FIG. 13 in the expanded position;

FIG. 16 is a perspective view of the outer wall of the collapsible baby bottle of FIG. 13 in the expanded position illustrating the releasable locking mechanism;

FIG. 17 is a perspective view of the outer wall of the collapsible baby bottle of FIG. 13 in the expanded position illustrating the releasable locking mechanism;

FIG. 18 is a perspective view in cross section of outer wall of the collapsible baby bottle of FIG. 13 in the collapsed position;

FIG. 19 is a perspective view of a collapsible water bottle in accordance with the present invention in an expanded position;

FIG. 20 is a perspective view in cross section of the outer wall of the collapsible water bottle of FIG. 19 in the collapsed position illustrating the releasable locking mechanism;

FIG. 21 is a perspective view of a collapsible storage container in accordance with the present invention in an expanded position;

FIG. 22 is a perspective view in cross section of the collapsible storage container of FIG. 21 in the expanded position illustrating the releasable locking mechanism;

FIG. 23 is a perspective view of the collapsible storage container of FIG. 21 in the collapsed position;

FIG. 24 is a perspective view in cross section of the collapsible storage container of FIG. 21 in the collapsed position illustrating the releasable locking mechanism;

FIG. 25 is a rear perspective view of a collapsible suitcase in accordance with the present invention in an expanded position;

FIG. 26 is a front perspective view of the collapsible suitcase of FIG. 25 in an expanded position;

FIG. 27 is a perspective view in cross section of the collapsible suitcase of FIG. 25 in the expanded position illustrating the releasable locking mechanism;

FIG. 28 is a rear perspective view of the collapsible suitcase of FIG. 25 in collapsed position;

FIG. 29 is a perspective view in cross section of the collapsible suitcase of FIG. 25 in the collapsed position illustrating the releasable locking mechanism;

FIG. 30 is a perspective view of the collapsible suitcase of FIG. 25 in the expanded position illustrating the use of the suitcase; and

FIG. 31 is a perspective view in cross section of the collapsible suitcase of FIG. 25 in the expanded position illustrating the use of the suitcase.

### DETAILED DESCRIPTION OF THE PREFERRED EMBODIMENTS

The present invention is directed to a collapsible container which is easily movable from a collapsed position having a reduced volume for storage and transport and an expanded position having dimensional rigidity and securely holding the contents of the container. The collapsible container has a plurality of outer wall segments having a side wall with a first and second edge, the outer wall segments being movable from a collapsed position wherein the plurality of outer wall segments are stacked within each other such that the height of the collapsed container is similar to the height of the individual outer wall segments and an expanded position for use of the collapsible container. The outer wall segments are provided with releasable locking means whereby the outer wall segments may be locked one to another in the expanded position and being releasable to allow for the collapsible container to be moved to the collapsed position. The releasable locking means are a releasable locking latch means adjacent a first edge of each of the outer wall segments and a locking latch means receptacle adjacent a second edge of the outer wall segments, the releasable locking latch means of an outer wall segment cooperating with the releasable locking latch means receptacle of an adjacent outer wall segment to releasably lock the collapsible container in the expanded position, the releasable locking latch means of an outer wall segment being disengageable from the releasable locking latch means receptacle of the adjacent outer wall segment to allow the collapsible container to be moved to the collapsed position. Various preferred embodiments of the present invention are described below.

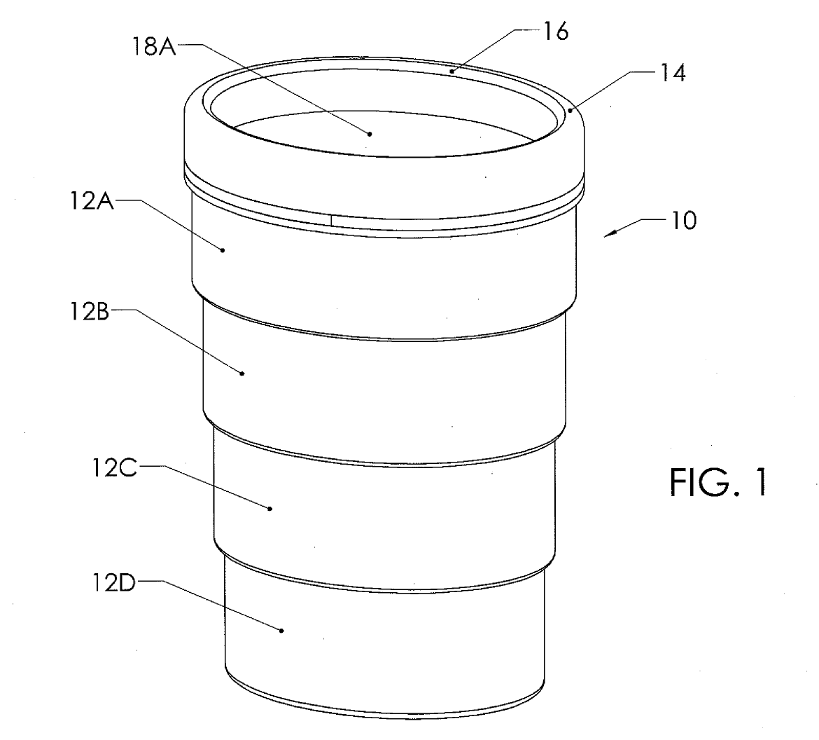

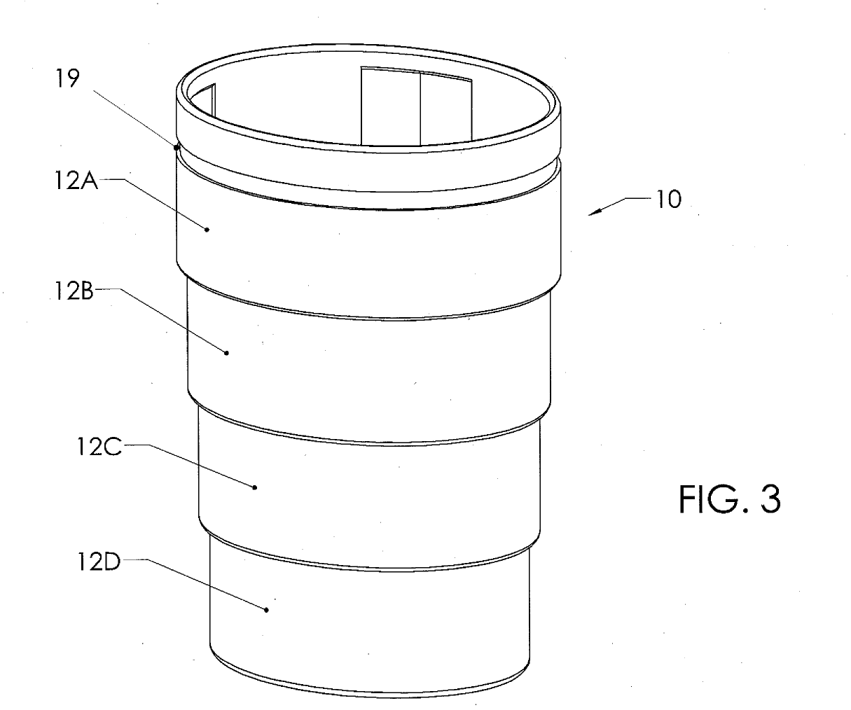

A first embodiment of a collapsible container, namely a collapsible cup, in accordance with the present invention is illustrated in FIGS. 1 to 6 generally indicated by the numeral 10. The collapsible cup 10 may be used for the transport and consumption of liquids such as coffee or tea. Once the liquid in the container has been consumed, the container may be collapsed to take up less space as the empty container is being transported.

The collapsible cup 10 has an outer wall 12 constructed of a plurality of outer wall segments 12A to 12D which are nestable within one another when the collapsible cup 10 is in the collapsed position as will be described in detail below. The total number of outer wall segments is a fraction of the volume required.

The collapsible cup 10 is also provided with an inner liner 14 which has an upper foldover lip 16 which folds over the top of the uppermost outer wall segment 12A. The uppermost outer wall segment 12A is provided with an exterior groove 19 which accepts an inner rib 21 on the interior of the foldover lip 16 of the inner liner 14 to securely connect the inner liner 14 to the outer wall 12.

The collapsible cup may be provided with a removable lid to allow for the transport and consumption of liquids carried within the collapsible cup. The removable lid may have an exterior rim to sit in a friction fit sealing arrangement over the foldover lip of the inner liner. The upper surface of the lid may be is provided with an opening to allow the user to consume the liquid in the collapsible container. The opening may be provided with a closure means such as a slidable cover to allow the opening to be covered when not in use to reduce the risk of spillage of the contents of the collapsible cup.

The inner liner 14 has an inner wall 18 formed of a plurality of inner wall segments 18A to 18D. The adjacent inner wall segments are joined to one another by a living hinge arrangement 28 which allows the inner liner wall 18 to collapse with the outer wall 12 as will be described below.

The inner liner 14 is also provided with a bottom 23 which is contiguous with the lowermost inner wall segment 18D. The exterior of the inner wall bottom 23 is provided with a locking disk 25 which passes through an opening 27 in the bottom of the lowermost outer wall segment 12B to securely connect the inner wall bottom to the outer wall bottom.

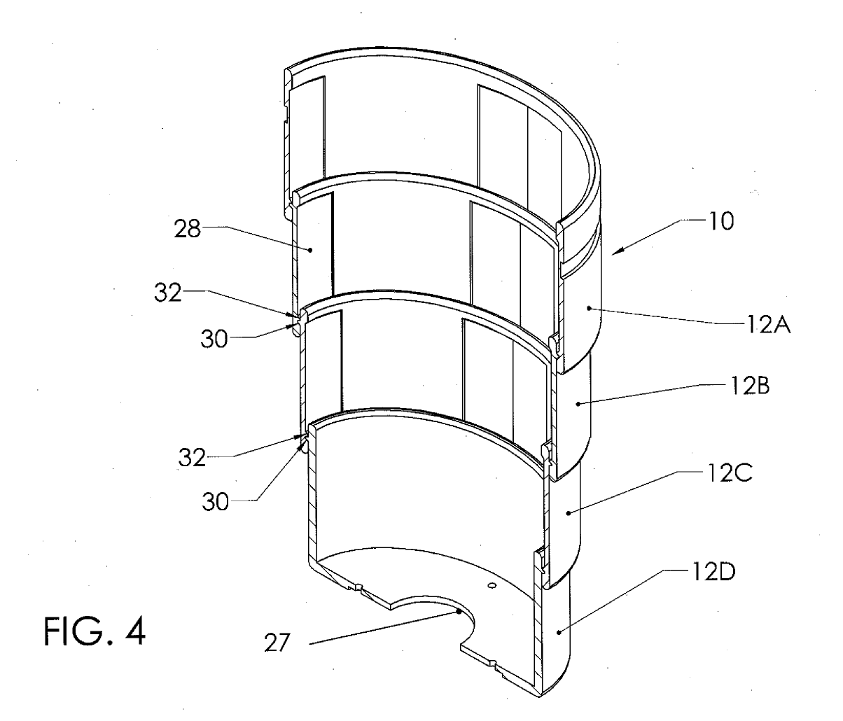

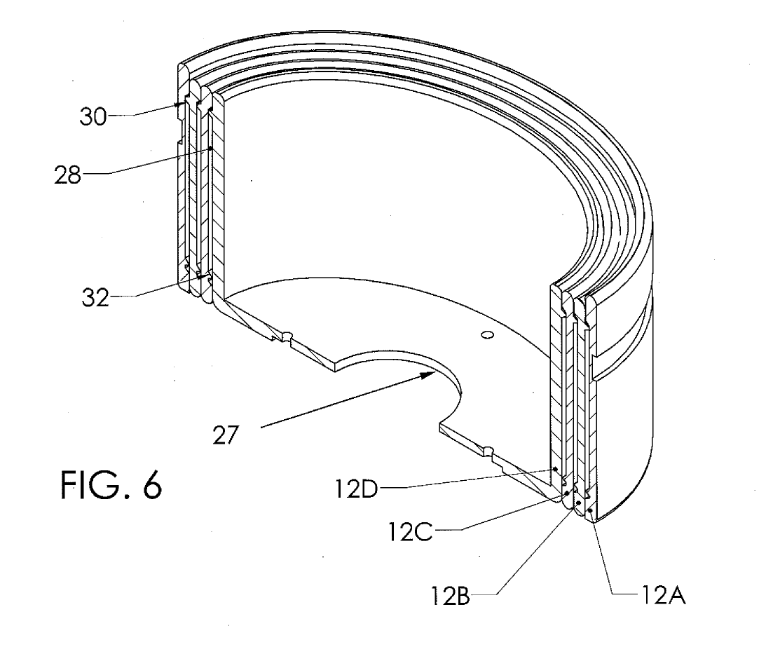

The outer wall segments 12A to 12D are provided with releasable locking means which allow the collapsible cup 10 to be expanded and locked in the expanded configuration while at the same time allowing the locking means to be released and allow the collapsible cup 10 to be collapsed to the collapsed configuration. One such releasable locking means is illustrated in FIGS. 4 and 6 in particular.

The interior of the outer wall segments 12A to 12C other than the lowermost segment 120 are provided with an elongate indent 28 which extends perpendicularly preferably almost the full height of the outer wall segments 12A to 12C. A releasable locking latch receptacle, namely a groove 30 is provided adjacent the lower end of the elongate indent 28. Each of the outer wall segments 12B to 12D other than the uppermost outer wall segment 12A, are provided with releasable latching means, namely exterior ribs 32 adjacent the top of the outer wall segment 12B to 12D. The exterior ribs 32 are of a size and shape to be contained within the elongate indent 28 on the interior surface of the adjacent outer wall segment 12A to 12C.

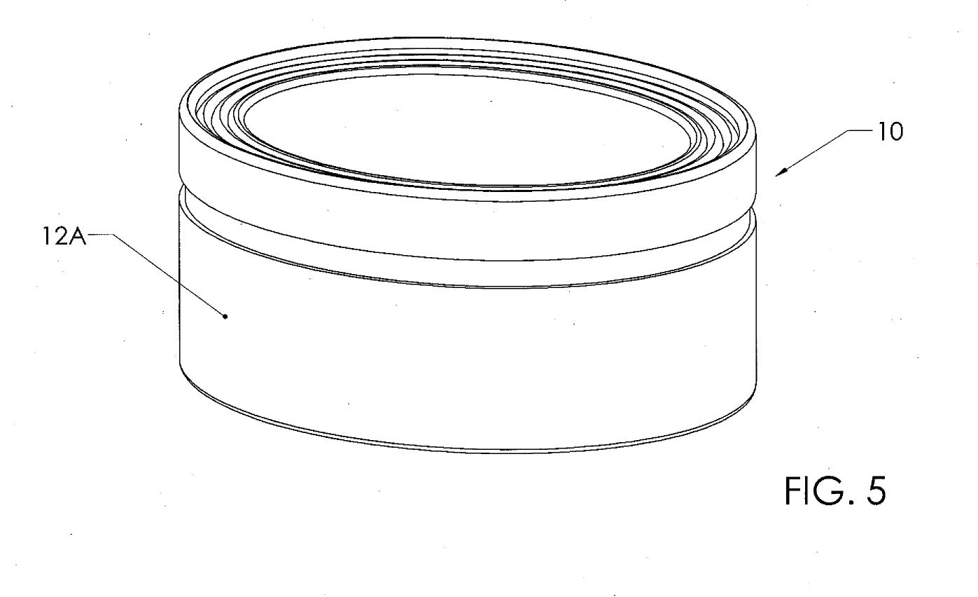

To expand the collapsible cup 10, starting from the collapsed configuration as shown in FIGS. 5 and 6, the uppermost outer wall segment 12A is gripped and pulled upwardly. The exterior ribs 32 ride within the elongate indents 28 until they snap into the grooves 30. This same operation is repeated for each of the outer wall segments until the collapsible container is in the expanded configuration.

To collapse the collapsible cup 10, the top of the cup 10 is pushed downwardly. For this movement, the cup 10 may be placed on a surface or the user may push on both the top and bottom of the cup 10 simultaneously. This movement forces the ribs 32 upwardly and out of the grooves 30 and into the elongate indents 28 until the ribs 32 rest against the upper edge of the elongate indent. The collapsible 10 cup is then in the collapsed position.

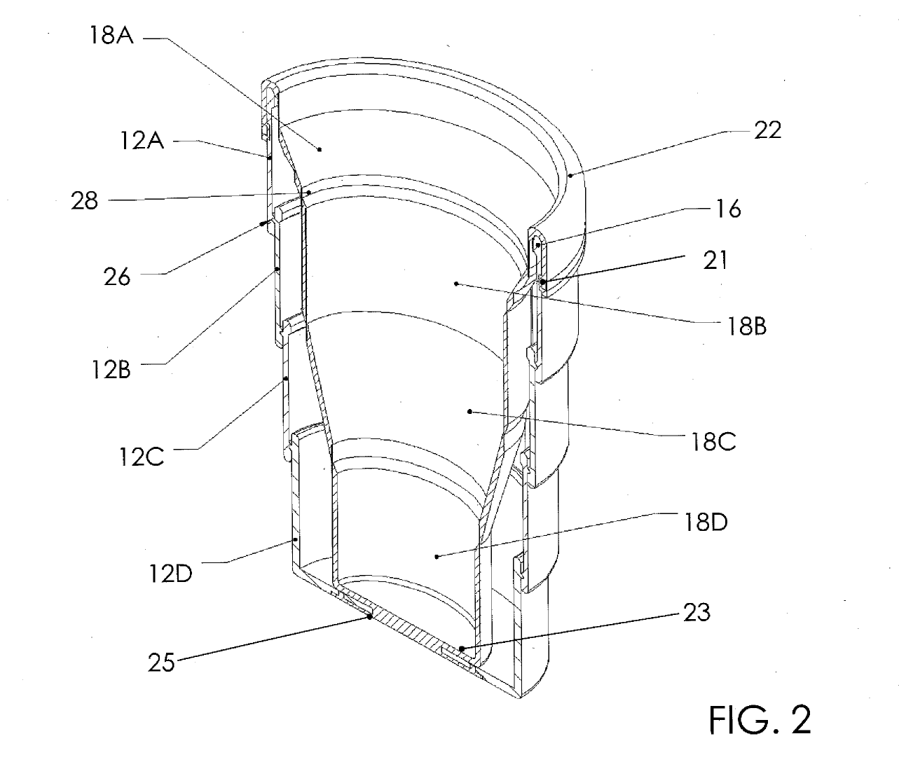

During the movement of the collapsible cup 10 into the collapsed position, the inner liner wall segments pivot about the living hinges joining the adjacent segments such that in the collapsed position, the inner wall segments form a pleated arrangement. During the expansion of the cup, the inner wall segments pivot about the living hinge to form the full inner liner in the expanded position as shown in FIG. 2. The liner may also be substituted for a sack or bag (not shown) of proportions to fit the cup volume.

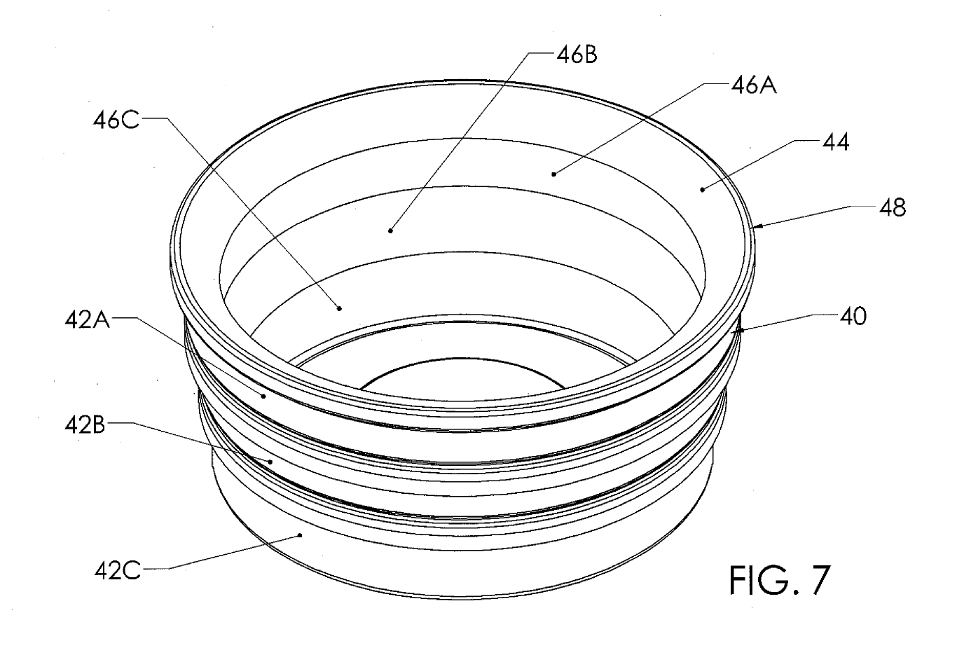

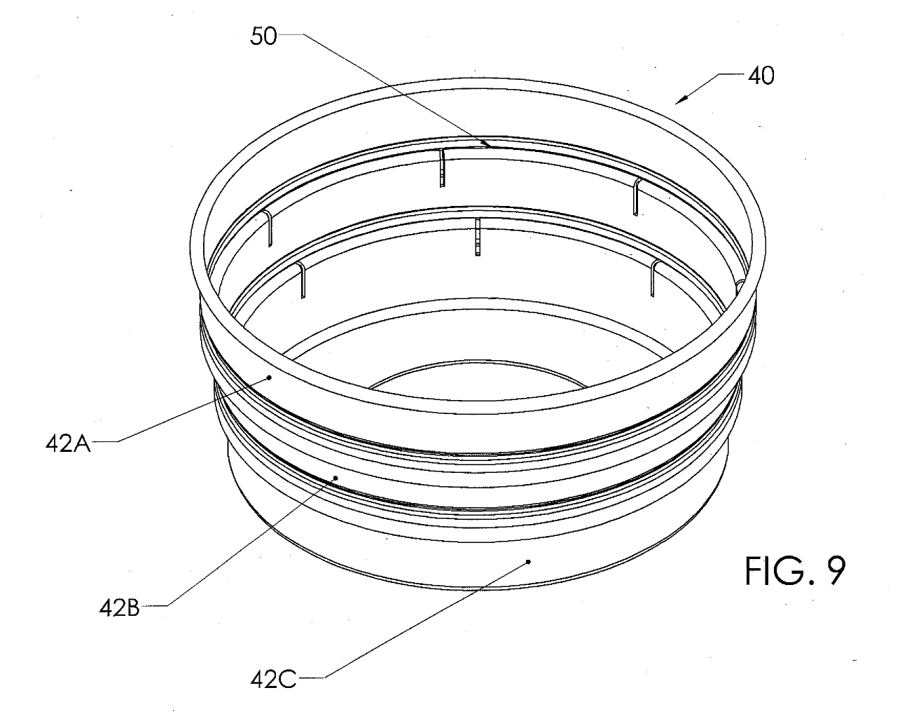

A second embodiment of a collapsible container of the present invention is illustrated in FIGS. 7 to 12. This embodiment is a collapsible wide-mouth container generally indicated by the numeral 40. This embodiment of the collapsible container could be used for the transport and consumption of foods such as soups or stews and as described below could also be used by hikers and campers.

The collapsible wide-mouth container has an outer wall 42 constructed of a plurality of segments 42A to 42C which are nestable within one another when the collapsible wide-mouth container 40 is in the collapsed position as will be described below. The total number of outer wall segments used is a fraction of the volume required.

The collapsible wide-mouth container 40 is also provided with an inner liner 44 which has an upper foldover lip 48 which folds over the top of the uppermost inner wall segment 42A. The uppermost outer wall segment 42A is provided with an exterior rollover lip 60 which accepts an inner groove 41 on the interior of the foldover lip 48 of the inner liner 44 to securely connect the inner liner 44 to the outer wall 42.

The inner liner 44 has an inner wall 46 formed of a plurality of inner wall segments 46A to 46C. The adjacent inner wall segments 46A to 46C are joined to one another by a living hinge arrangement 52 which allows the inner liner wall 46 to collapse with the outer wall 42 as will be described below.

The collapsible wide-mouth container 40 may be utilized by hikers or campers as a cooking container and thus the wide-mouth container is provided with a suitable bottom to allow it to be used on a stove or burner. The inner liner 44 is provided with a bottom 43 which is contiguous with the lowermost inner liner wall segment 46C. Similarly, the lowermost outer wall segment 42C is also provided with a bottom 45. The bottom 43 of the inner liner 46 and the bottom 45 of the outer wall 42 are both provided with an annular opening. Atop plate 47 and a bottom plate 49 of a suitable heat conducting material are provided which sandwich the bottom 43 of the inner layer 46 and bottom 45 of the outer wall 42 therebetween. In this way, the heat from a stove, integrated electric heating coil or burner is easily and rapidly transferred through the top plate 47 and bottom plate 49 and to the contents held within the wide-mouth container 40. Additional means of enhancing thermal transfer may also be employed such as fins to increase surface area.

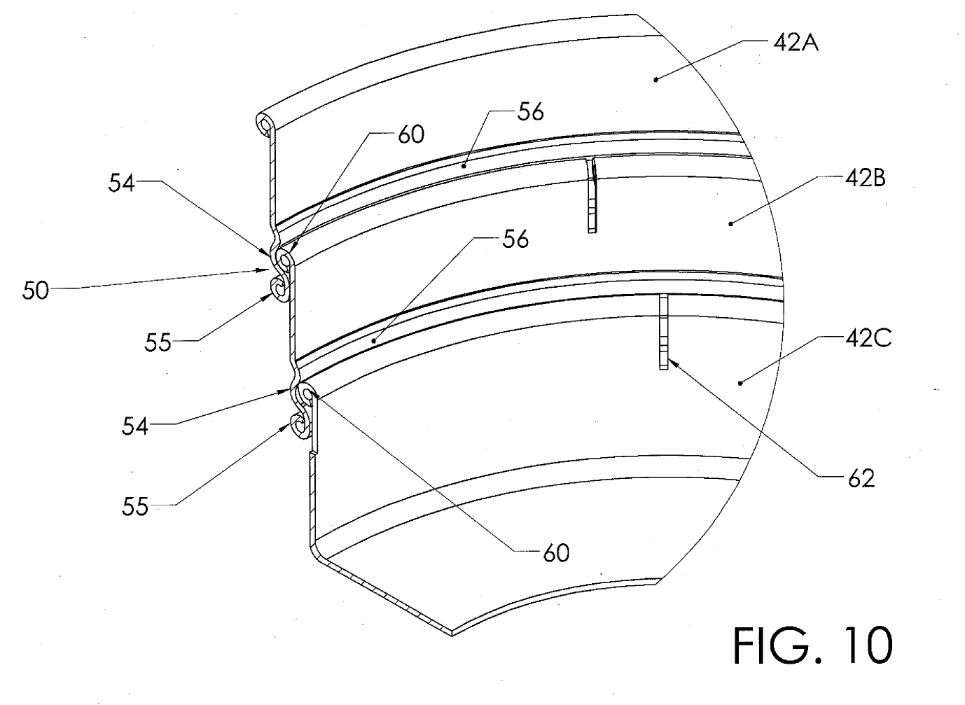

The outer wall segments 42A to 42C are provided with releasable locking means 50 which allow the collapsible wide-mouth container 40 to be expanded and locked in the expanded configuration while at the same time allowing the locking means 50 to be released and allow the collapsible wide-mouth container 40 to be collapsed to the collapsed configuration. One such releasable locking means 50 is illustrated in FIG. 10 in particular.

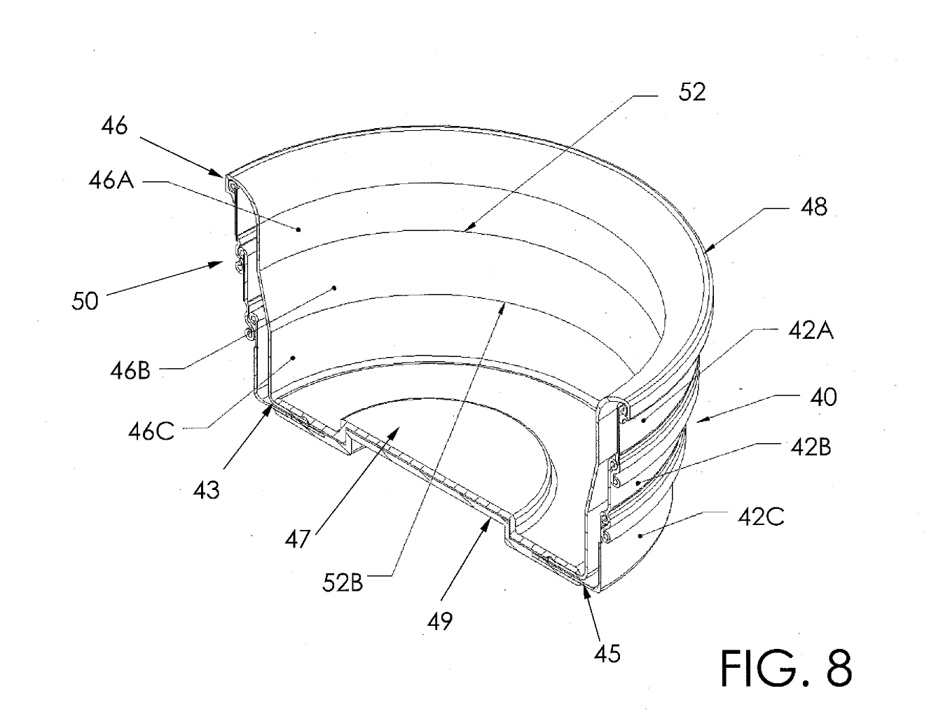

Each of the outer wall segments 42A to 42C are provided with a releasable locking latch means, namely a roll over top lip 60 which rolls over to the exterior of the segment. The uppermost wall segments 42A and 423 are also provided with a roll over bottom lip 55, also rolling over to the exterior of the container. The wall of the outer wall segments 42A and 42B immediately above the roll over bottom lip 55 are provided with a releasable locking latch means receptacle, namely an annular groove 54 on the interior surface of the outer wall segments and an annular rib 56 immediately above the annular groove. In the expanded configuration as shown in the figures, in particular, FIGS. 8 and 10, the roll over top lip 60 of the outer wall segment 42B or 420 is contained and held within the annular groove 54 of the immediately adjacent outer wall segment.

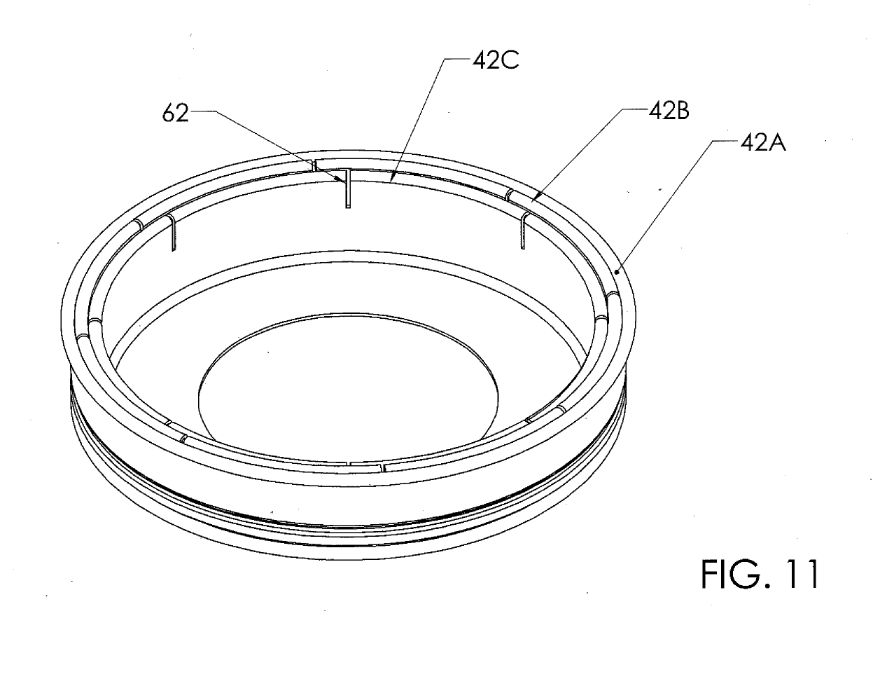

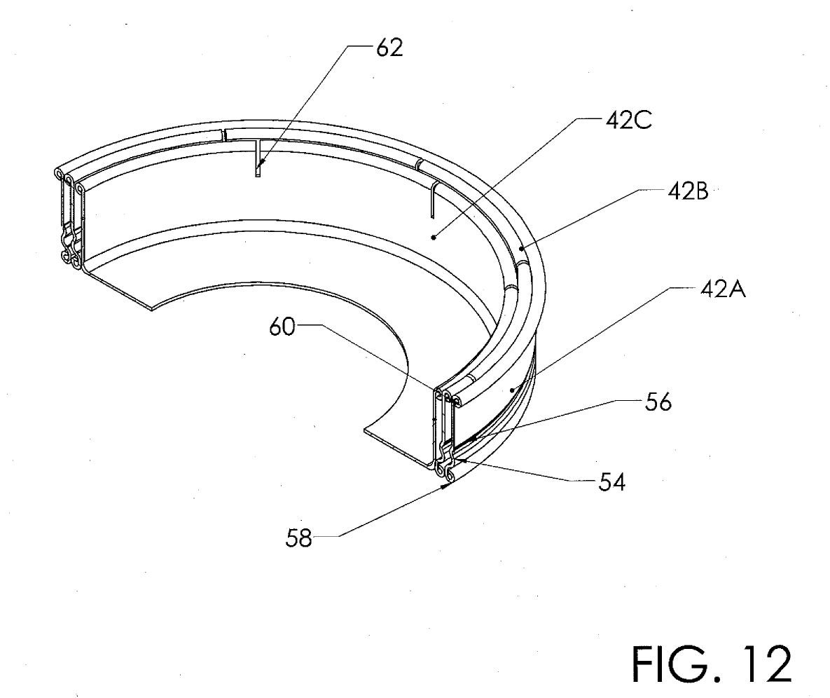

To expand the collapsible wide-mouth container 40, starting from the collapsed configuration as shown in FIGS. 11 and 12, the uppermost outer wall segment 42A is gripped and pulled upwardly. The rollover top lips 60 ride downwardly along the interior wall of the adjacent inner wall segment, then over the annular rib 56 until they snap into the annular grooves 54. The same operation is repeated for each of the outer wall segments until the collapsible wide-mouth container 40 is in the expanded configuration.

In order to allow for the necessary movement of the rollover top lip 60 inwardly and outwardly to seat in the annular grooves 54, the outer wall segments 422 and 42C are provided with slots 62 such that the rollover lip 60 is divided into a plurality of segments. Each of the segments may move inwardly and outwardly independent of the other segments thus allowing for the proper movement of the rollover top lip 60 during the collapsing and expanding movements

To collapse the collapsible wide-mouth container 40, the top of the wide-mouth container 40 is pushed downwardly. For this movement, the wide-mouth container 40 may be placed on a surface or the user may push on both the top and bottom of the wide-mouth container 40 simultaneously. This movement forces the rollover top lips 60 upwardly over the annular rib 56 and out of the annular grooves 54 and upwardly along the interior of the adjacent outer wall segment until the outer wall segments align. The collapsible wide-mouth container 40 is then in the collapsed position.

During the movement of the collapsible wide-mouth container 40 into the collapsed position, the inner liner wall segments 46A to 460 pivot about the living hinges 52A and 52B joining the adjacent segments such that in the collapsed position, the inner wall segments form a pleated arrangement. During the expansion of the wide-mouth container 40, the inner wall segments 46A to 46C pivot about the living hinges 52A and 52B to form the full inner liner in the expanded position as shown in FIGS. 7 and 8.

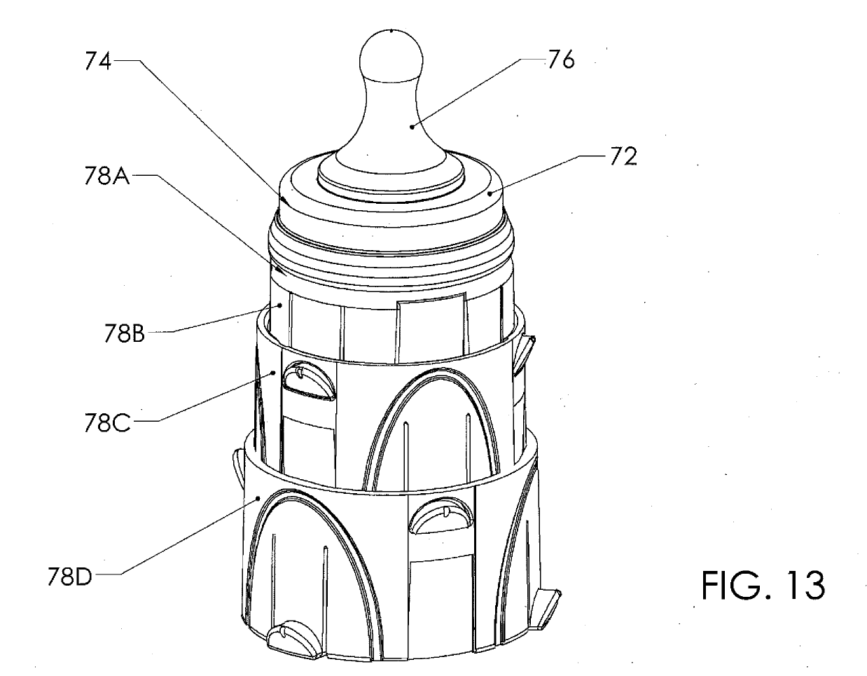

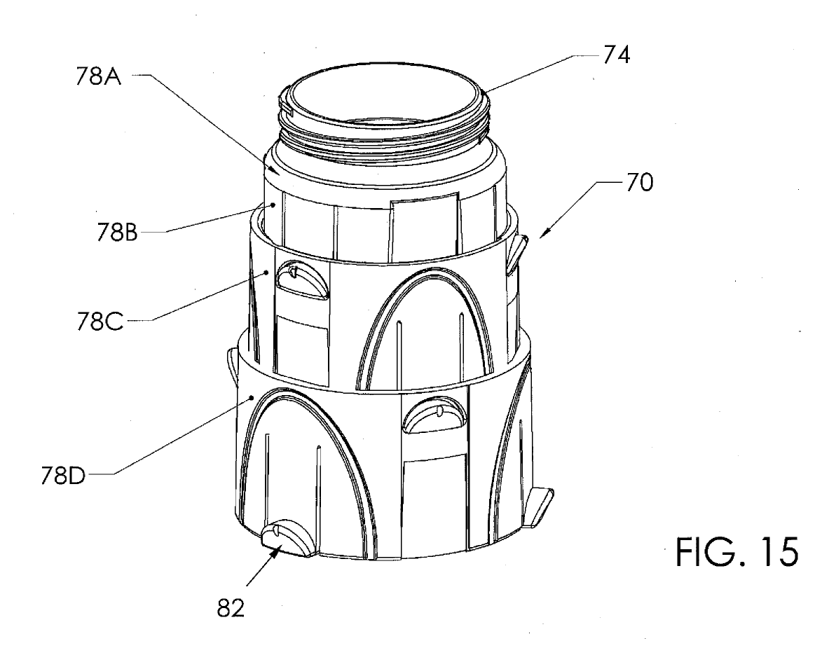

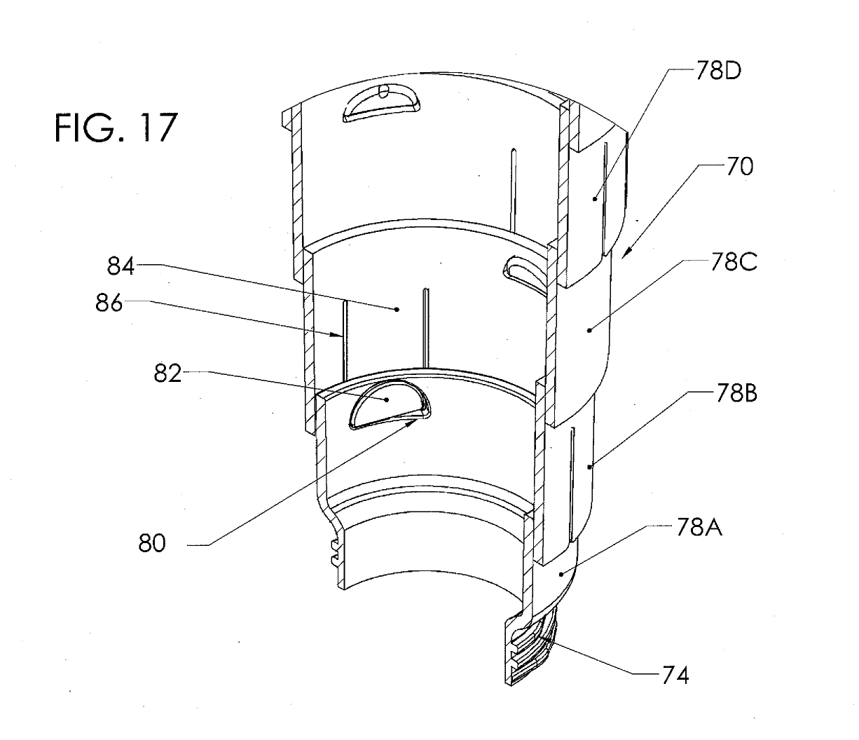

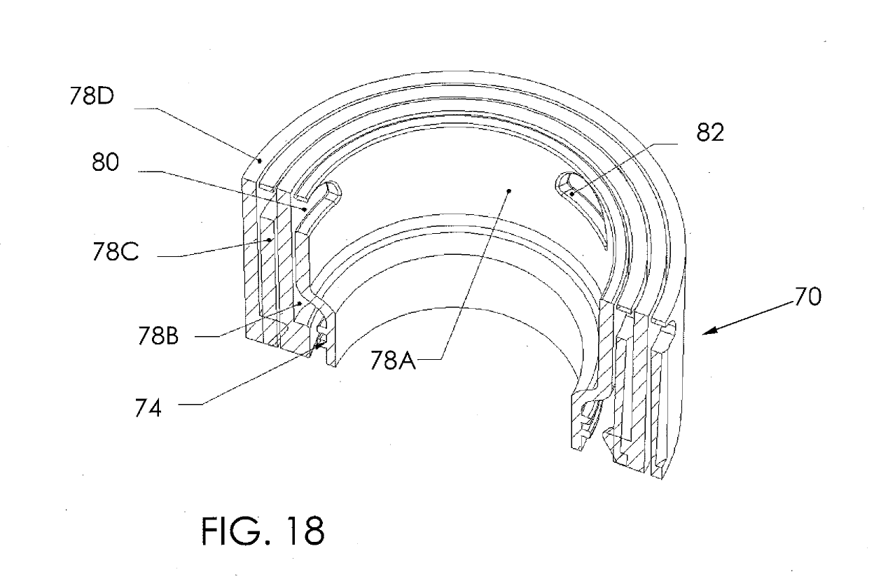

A third embodiment of a collapsible container of the present invention is illustrated in FIGS. 13 to 18. This embodiment of the collapsible container is a collapsible baby bottle or sipping cup generally indicated by the numeral 70. The collapsible baby bottle 70 has an outer wall 78 constructed of a plurality of outer wall segments 78A to 78D. The uppermost outer wall segment 78A is provided with an exterior thread 74 which accepts a standard retaining ring 72 to hold a nipple 76 or sipping top or other lid (not shown) on the top of the collapsible baby bottle 70. A standard baby bottle liner is used in the conventional manner to hold the formula or other fluid for consumption by the baby or toddler.

The outer wall segments 78A to 78D are provided with releasable locking means which allow the collapsible baby bottle 70 to be expanded and locked in the expanded configuration while at the same time allowing the locking means to be released and allow the collapsible baby bottle 70 to be collapsed to the collapsed configuration. One such releasable locking means is illustrated in FIGS. 13 to 15 in particular.

Each of the outer wall segments 78A to 78D has a plurality of resilient locking tabs 84. The locking tabs 84 are separated from the wall of the outer wall segment by slots 86. In the embodiment illustrated in FIGS. 13 to 15, the locking tabs 84 are downwardly extending and the slots 86 extend upwardly more than half the height of the outer wall segment. However, as described below, other configurations are possible.

The lower end of the resilient locking tab 84 is provided with a releasable locking latch means, namely a generally semi-circular lug 82 which fits within a releasable locking latch means receptacle, namely a generally semi-circular opening 80 provided in an adjacent outer wall segment as will be described. Preferably, the semicircular lug 82 has a flat base contiguous with and extending outwardly of the resilient tab 84. The outer surface of the lug 82 extends upwardly and outwardly to the semicircular upper edge of the lug 82. Preferably, in order to aid in the locking and releasing of the lug 82 from the opening 80, the joint between the outer surface and the semicircular upper edge of the lug is cambered or rounded over and is not a sharp edge.

The outer wall segments 78B to 78D are provided with semicircular openings 80 of a size slightly larger than the size of the semicircular lugs 82 on the resilient tabs 84. The number of such semicircular openings 80 are the same as the number of resilient tabs 84 and semicircular lugs. 82 on the adjacent outer wall segment. In order to allow the semicircular lugs 82 to be biased inwardly during the collapsing operation, the exterior of the outer wall segment below the semicircular opening 80 is provided with an indent extending downwardly from the semicircular opening 80.

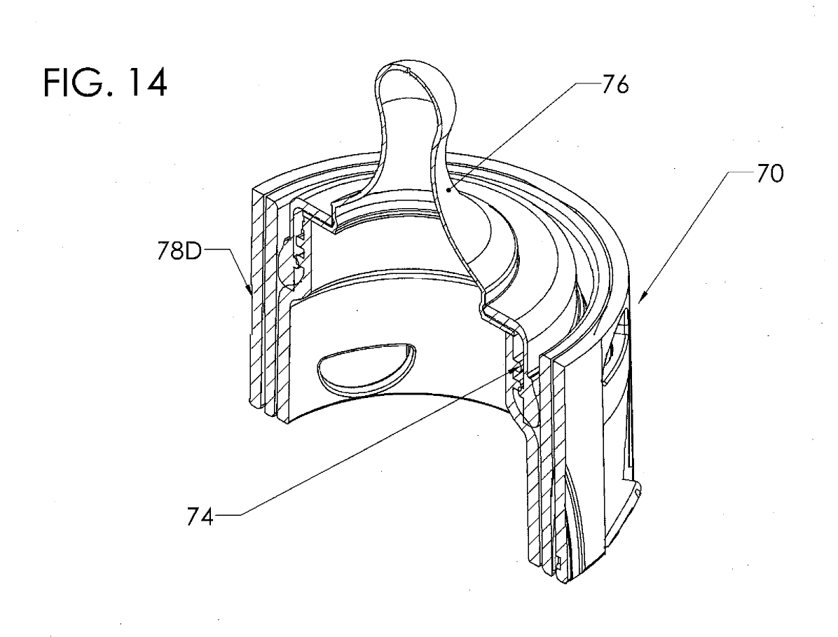

To expand the collapsible baby bottle 70, starting from the collapsed configuration as shown in FIG. 14, the outermost outer wall segment 78D is gripped and pulled downwardly. The semicircular lugs 82 ride upwardly along the interior wall of the adjacent outer wall segment, then snap into the semicircular opening 80. The same operation is repeated for each of the outer wall segments until the collapsible baby bottle 70 is in the expanded configuration.

To collapse the collapsible baby bottle 70, the semicircular lugs 82 are pressed inwardly until the top semicircular edge of the lug 82 passes the top of the semicircular opening. The outer wall segment is then pushed upwardly so that the resilient tab 84 and lug 82 cam inwardly and ride downwardly along the interior of the adjacent outer wall segment until the outer wall segments align. This process is repeated for each of the outer wall segments until the collapsible baby bottle 70 is then in the collapsed position.

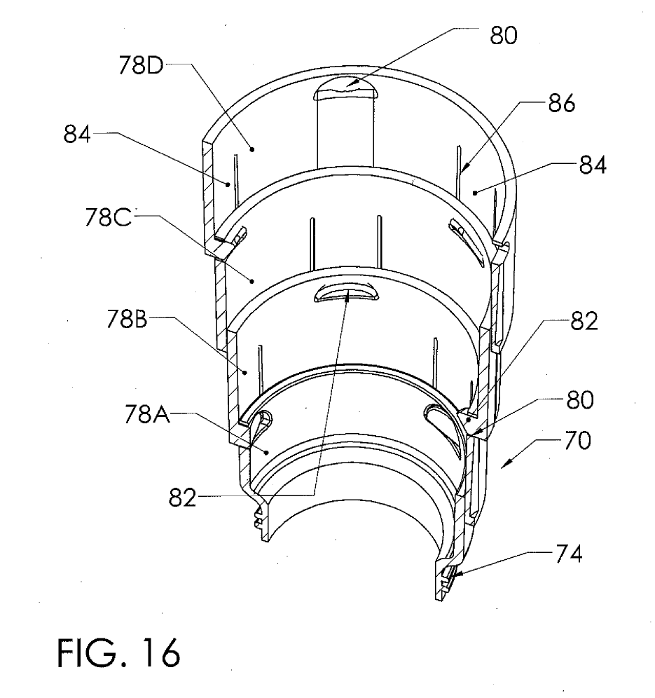

A further embodiment of a collapsible baby bottle 70 of the present invention is illustrated in FIGS. 16 to 18. Similar to the previous embodiment, the collapsible baby bottle 70 has an outer wall 78 constructed of a plurality of outer wall segments 78A to 78D. The uppermost outer wall segment 78A is provided with an exterior thread 74 which accepts a standard retaining ring 72 to hold a nipple 76 or sipping top (not shown) on the top of the collapsible baby bottle 70. A standard commercially available baby bottle liner (not shown) is used in the conventional manner to hold the formula or other fluid for consumption by the baby or toddler.

The outer wall segments 78A to 78D are provided with releasable locking means which similar to the previous embodiment are a plurality of resilient locking tabs 84. The locking tabs 84 are separated from the wall of the outer wall segment by slots 86. In the embodiment illustrated in FIGS. 16 to 18, the locking tabs 84 are upwardly extending and the slots 86 extend downwardly more than half the height of the outer wall segment.

The upper end of the resilient locking tab 84 is provided with an inwardly oriented generally semi-circular lug 82 which fits within a generally semi-circular opening 80 provided in an adjacent outer wall segment. Preferably, the semicircular lug 82 has a flat top contiguous with and extending inwardly of the resilient tab 84. The inner surface of the lug 82 extends downwardly to the semicircular lower edge of the lug 82. The inner surface of the lug is at an angle to the interior surface of the outer wall segment such that one side of the lug is generally contiguous with the resilient tab. Preferably, in order to aid in the locking and releasing of the lug 82 from the opening 80, the joint between the outer surface and the semicircular lower edge of the lug is cambered or rounded over and is not a sharp edge.

The outer wall segments 78B to 78D are provided with semicircular openings 80 of a size slightly larger than the size of the semicircular lugs 82 on the resilient tabs 84. The number of such semicircular openings 80 are the same as the number of resilient tabs 84 and semicircular lugs 82 on the adjacent outer wall segment. In order to allow the semicircular lugs 82 to be biased inwardly during the collapsing operation, the exterior of the outer wall segment above the semicircular opening 80 is provided with an indent extending upwardly from the semicircular opening 80.

To expand the collapsible baby bottle 70, starting from the collapsed configuration as shown in FIG. 14, the outermost outer wall segment 78D is gripped and pulled downwardly. The semicircular lugs 82 ride downwardly along the exterior wall of the adjacent outer wall segment, then snap into the semicircular opening 80. The same operation is repeated for each of the outer wall segments until the collapsible baby bottle 70 is in the expanded configuration.

To collapse the collapsible baby bottle 70, the outer wall segments are rotated slightly such that the semicircular lugs 82 are caromed outwardly until the lug 82 is released from the semicircular opening 80. The outer wall segment is then pushed upwardly so that the resilient tab 84 and lug 82 rides upwardly along the exterior of the adjacent outer wall segment until the outer wall segments align. This process is repeated for each of the outer wall segments until the collapsible baby bottle 70 is then in the collapsed position.

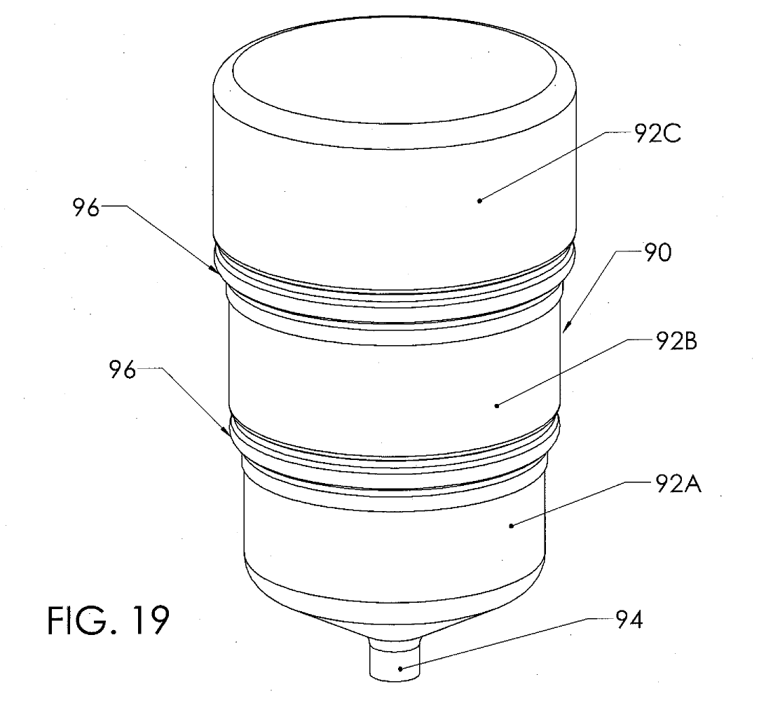

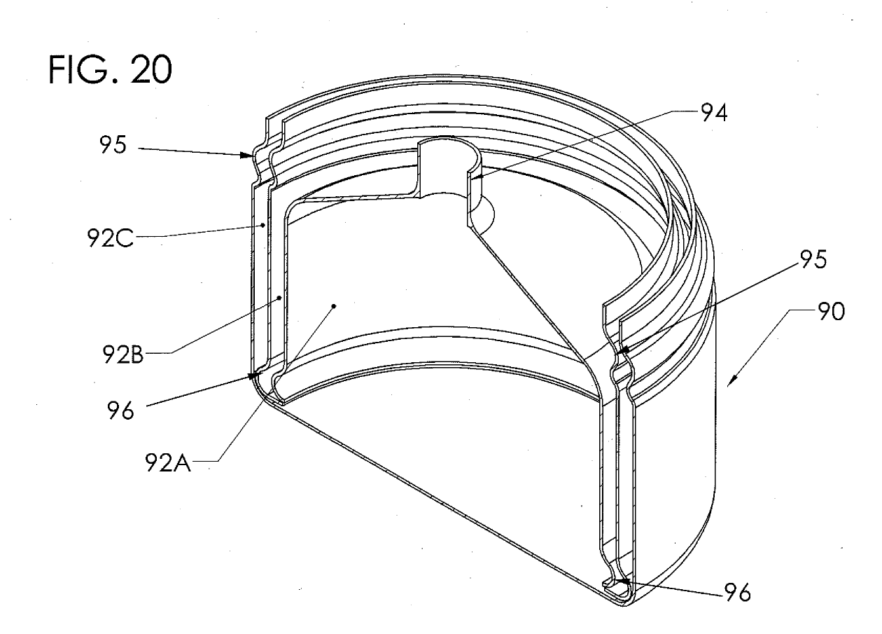

A further embodiment of the collapsible container of the present invention is illustrated in FIGS. 19 and 20. This embodiment is a collapsible water bottle for use in portable water coolers and the like. The collapsible water bottle 90 has an outer wall 92 constructed of a plurality of segments 92A to 92C which are nestable within one another when the collapsible water bottle 90 is in the collapsed position.

In the embodiment illustrated in the figure, the collapsible water bottle 90 has three segments 92A to 92C. The upper most segment 92A has at its upper edge an upwardly and inwardly sloping top to a neck 94 which fits within the receptacle of the water cooler in the typical manner. The lower most of the segments 92C is provided at its lower edge with a bottom contiguous with the lower edge of the segment.

The collapsible water bottle 90 may be provided with an inner liner similar to the embodiments described above or the releasable locking means may be constructed in a manner to maintain the water bottle in a water tight configuration when in the expanded position.

The outer wall segments 92A to 92C are provided with releasing locking means which allow the collapsible water bottle 90 to be expanded and locked in the expanded configuration while the same time allowing the locking means to be released and allow the collapsible water bottle 90 to be collapsed in the collapsed configuration. One such locking means is illustrated in FIG. 20. The upper most wall segments 92A and 92B are provided at the lower edge thereof with releasable locking latch means, namely an annular ring 96 which extends outwardly of the outer wall segment adjacent the lower edge. The upper most wall segments are provided with a releasable locking latch means receptacle 95 for the annular rib of the immediately adjacent outer wall segment. Preferably as illustrated in FIG. 20, this releasable locking latch means receptacle 95 is located adjacent the upper edge of the outer wall segment and comprises an annular inwardly oriented rib and immediately above the annular inwardly oriented rib is an outwardly oriented annular groove. In the expanded configuration of FIG. 19, the annular rib on the lower edge of an outer wall segment is contained and held within the annular groove of the immediately adjacent outer wall segment.

To expand the collapsible water bottle starting from the collapsed configuration as shown in FIG. 20, the upper most wall segment 92A is gripped and pulled upwardly, the annular rib rides upwardly along the interior wall of the adjacent outer wall segment, then over the annular rib until it snaps into the annular groove. The same operation is repeated for each of the outer wall segments until the collapsible the wide mouth water bottle is in the expanded configuration.

To collapse the collapsible water bottle 90, the top of the water bottle is pushed downwardly. For this movement, the collapsible water bottle 90 may be placed on a surface that the user may push on both the top and bottom of the water bottle 90 simultaneously. This movement forces the annular rib on the exterior of the outer wall segment over the annular rib on the interior of the adjacent outer wall segment and out of the annular grooves and downwardly along the interior of the adjacent outer wall segment until the outer wall segments align. The collapsible water bottle 90 is then in a collapsed configuration.

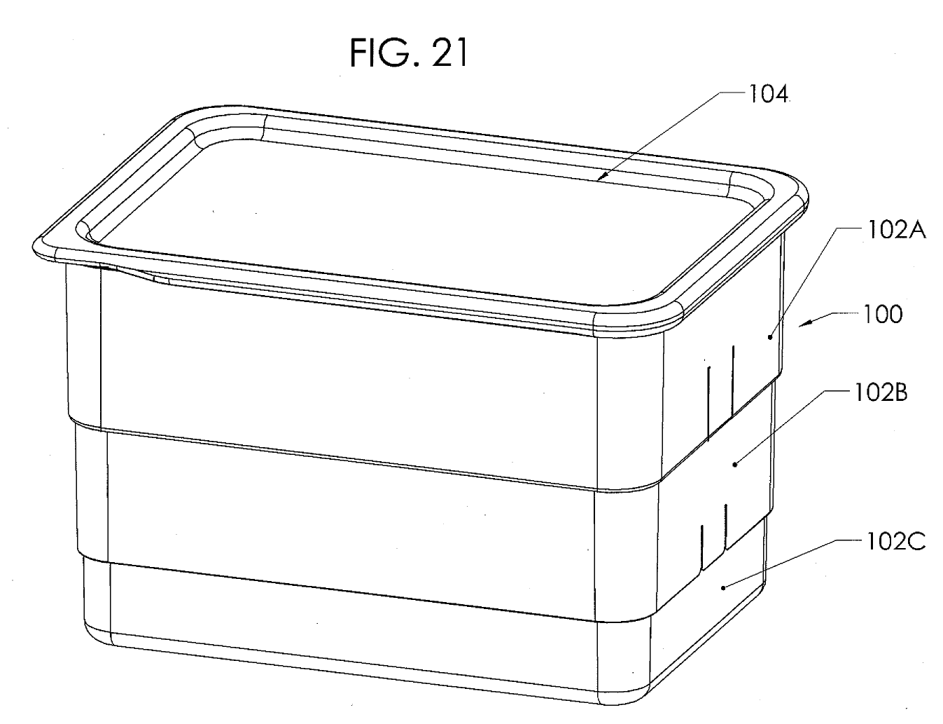

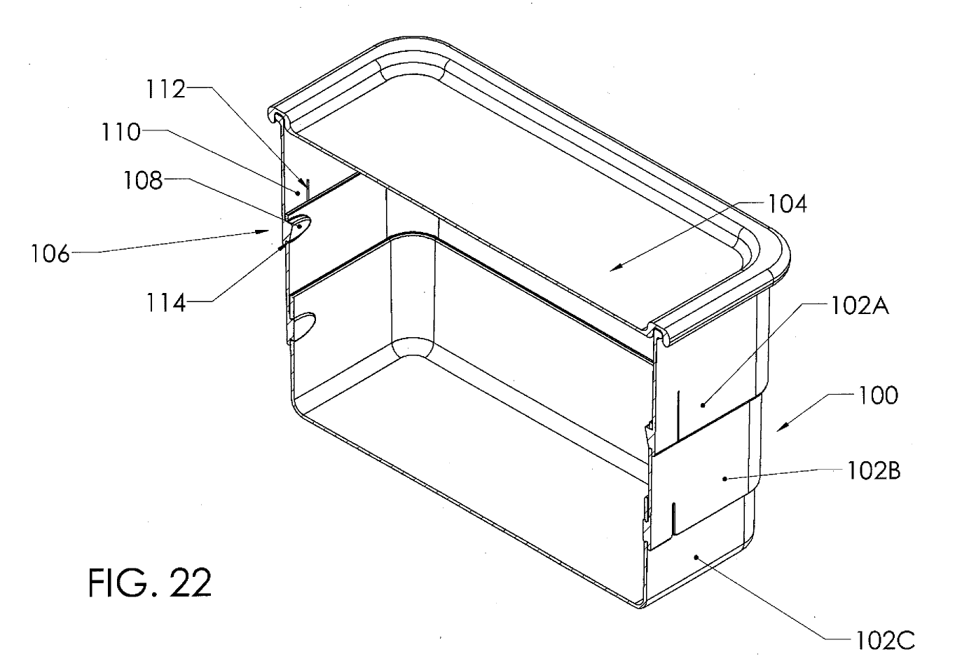

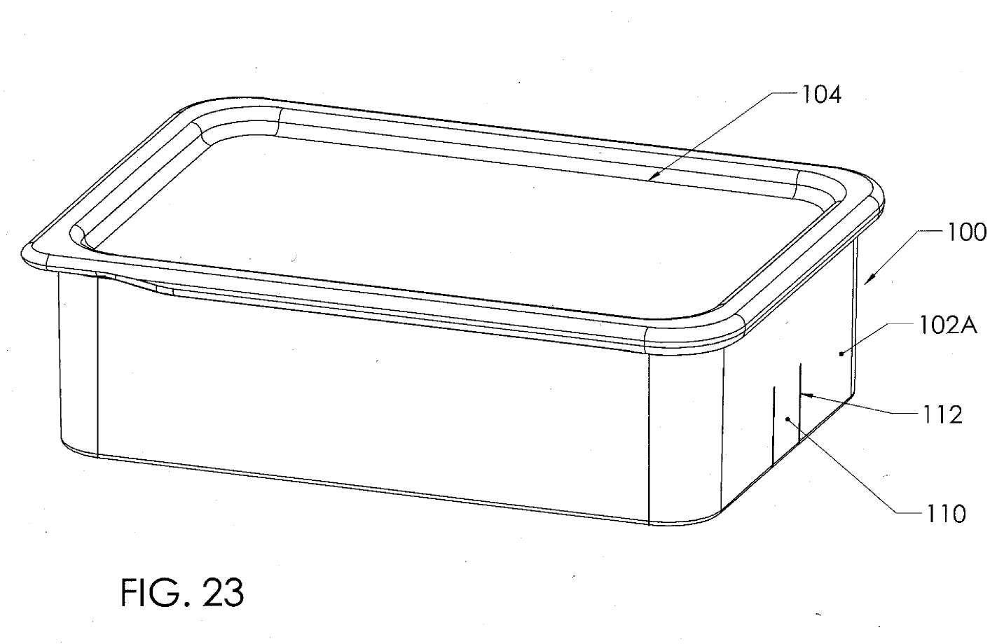

A further embodiment of a collapsible container of the present invention is illustrated in FIGS. 21 to 24. This embodiment of the collapsible container is a collapsible storage container generally indicated by the numeral 100. The collapsible storage container allows the interior volume of the storage container to be adjusted depending upon the volume of materials to be stored within the container. In this way, there is a reduction in the amount of wasted space where the container is used for storage of a smaller volume of material, yet may be easily expanded to accommodate more material.

The collapsible storage container has an outer wall 102 constructed of a plurality of outer wall segments 102A to 102C. The upper most outer wall segment 102A is provided with a rollover upper lip to permit a cover 104 to be snapped or friction fitted onto the storage container in a conventional manner. The lower most outer wall segment 102C is provided with a bottom contiguous with the lower edge of the outer wall segment 102C.

The outer wall segments 102A to 102C are provided with releasable locking means which allow the collapsible storage container 100 to be expanded and locked in the expanded configuration while at the same time allowing the locking means to be released and allow the collapsible storage container to be collapsed in a collapsed configuration. One such releasable locking means is illustrated in the figures.

Each of the upper most outer wall segments 102A and 102B are provided with a plurality of resilient locking tabs 110. The locking tabs are separated from the wall of the outer wall segment by slots 112. In the embodiment illustrated in the figures, the locking tabs 110 are downwardly extending and the slots extend upwardly; however, other configurations are possible and would be immediately apparent to those of skill in the art.

The lower end of the resilient locking tab 110 is provided with the releasable locking latch means, namely a generally semicircular lug 108 which fits within a releasable locking latch means receptacle, namely a generally semicircular opening 114 provided in an adjacent outward wall segment as will be described. Preferably, the semicircular lug has a flat base contiguous with and extended outwardly of the resilient tab 110. The lug extends upwardly and outwardly from the base to a semicircular upper edge of the lug. Preferably to aid in the locking and releasing of the lug from the opening, the joint between the outer surface and semicircular upper edge of the lug is cambered or rounded over and is not a sharp edge.

The outer wall segments 102B and 1020 are provided with a semicircular opening 114 of a size slightly larger than the size of the semicircular lugs on the resilient tabs. The number of such semicircular openings are the same as the number of resilient tabs and semicircular lugs on the adjacent outer wall segment.

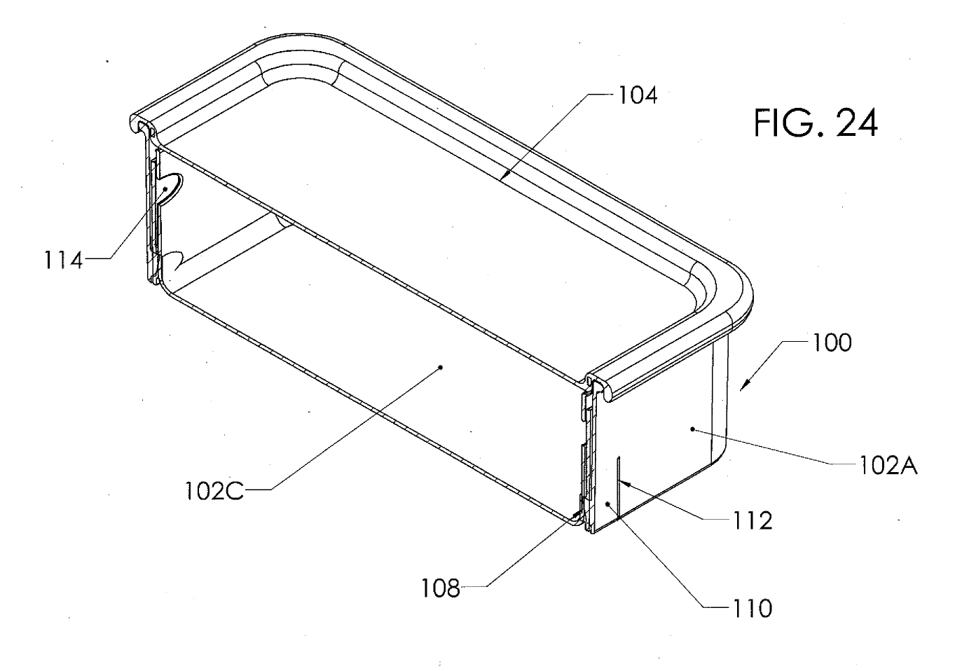

To expand the collapsible storage container starting from the collapsed configuration as shown in FIG. 24, the outer most outer wall segment 102A is gripped and pulled upwardly. The semicircular lugs 108 ride upwardly along the exterior wall of the adjacent outer wall segment, then snap into the semicircular opening 114. The same operation is repeated for each of the outer wall segments until the collapsible storage container is in the expanded configuration.

To collapse the collapsible storage container, the semicircular lugs are pressed outwardly until the base of the lug passes the lower edge of the semicircular opening. The outer wall segment is then pushed downwardly so that the resilient tab and lug cam outwardly and ride downwardly along the exterior of the adjacent outer wall segment until the outer wall segments align. This process is repeated for each of the outer wall segments until the collapsible storage container is then in the collapsed position.

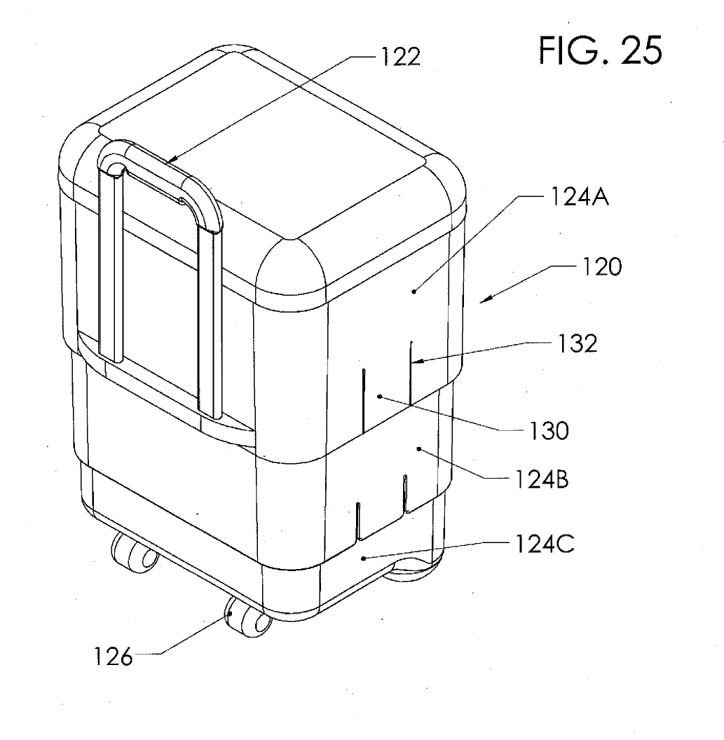

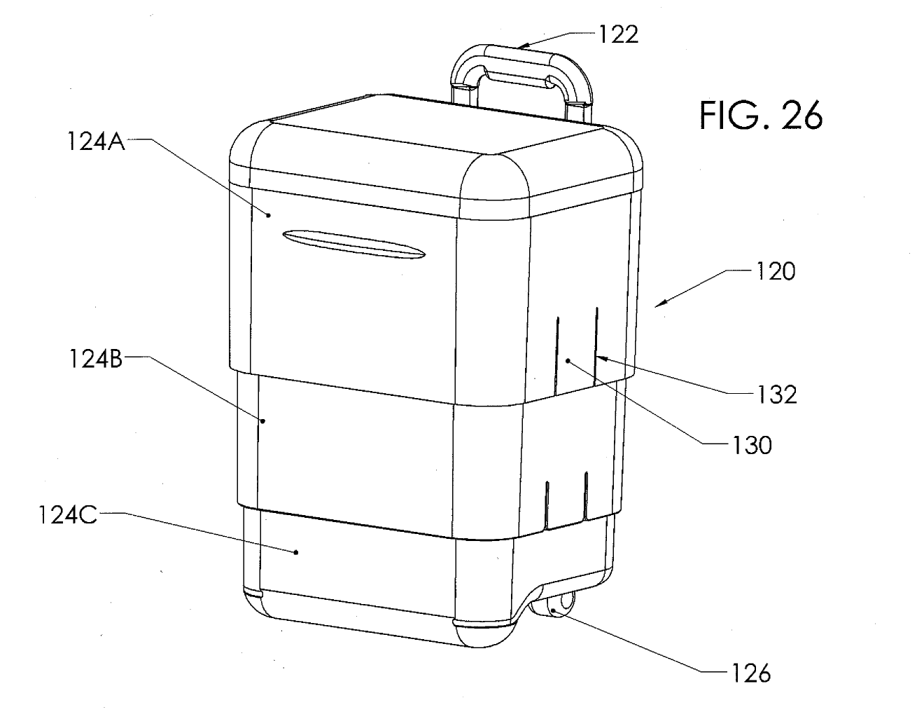

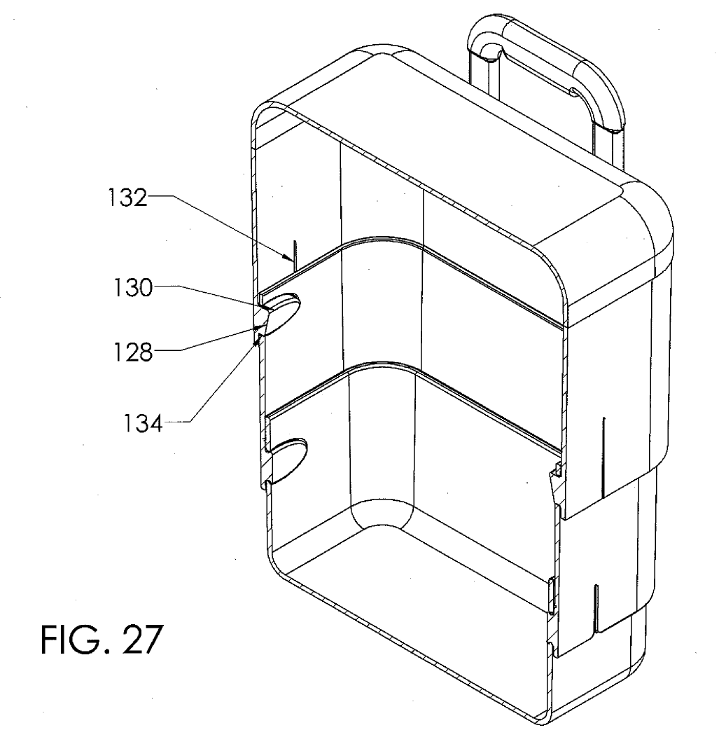

A further embodiment of a collapsible container of the present invention is illustrated in FIGS. 25 to 31. This embodiment of the collapsible container is a collapsible suitcase generally indicated by the numeral 120. The collapsible suitcase has an outer wall 124 constructed of a plurality of outer wall segments 124A to 124C. The upper most outer wall segment 124A is provided with a releasable and removable cover to permit access to the interior of the collapsible suitcase in a conventional manner. The lower most outer wall segment 124C is provided with a bottom contiguous with the lower edge of the outer wall segment 124C.

The outer wall segments 124A to 124C are provided with releasable locking means which allow the collapsible suitcase 120 to be expanded and locked in the expanded configuration while at the same time allowing the locking means to be released and allow the collapsible suitcase to be collapsed in a collapsed configuration. One such releasable locking means is illustrated in the figures.

Each of the upper most outer wall segments 124A and 124B are provided with a plurality of resilient locking tabs 130. The locking tabs 130 are separated from the wall of the outer wall segment by slots 132. In the embodiment illustrated in the figures, the locking tabs 130 are downwardly extending and the slots 132 extend upwardly; however, other configurations are possible and would be immediately apparent to those of skill in the art.

The lower end of the resilient locking tab 130 is provided with the releasable locking latch means, namely a generally semicircular lug 128 which fits within a releasable locking latch means receptacle, namely a generally semicircular opening 134 provided in an adjacent outward wall segment as will be described. Preferably, the semicircular lug 128 has a flat base contiguous with and extending outwardly of the resilient tab 130. The lug 128 extends upwardly and outwardly from the base to a semicircular upper edge of the lug. Preferably to aid in the locking and releasing of the lug 128 from the opening of the joint between the outer surface and semicircular upper edge of the lug is cambered or rounded over and is not a sharp edge.

The outer wall segments 124B and 124C are provided with a semicircular opening 134 of a size slightly larger than the size of the semicircular lugs 128 on the resilient tabs 130. The number of such semicircular openings 134 are the same as the number of resilient tabs 130 and semicircular lugs 128 on the adjacent outer wall segment.

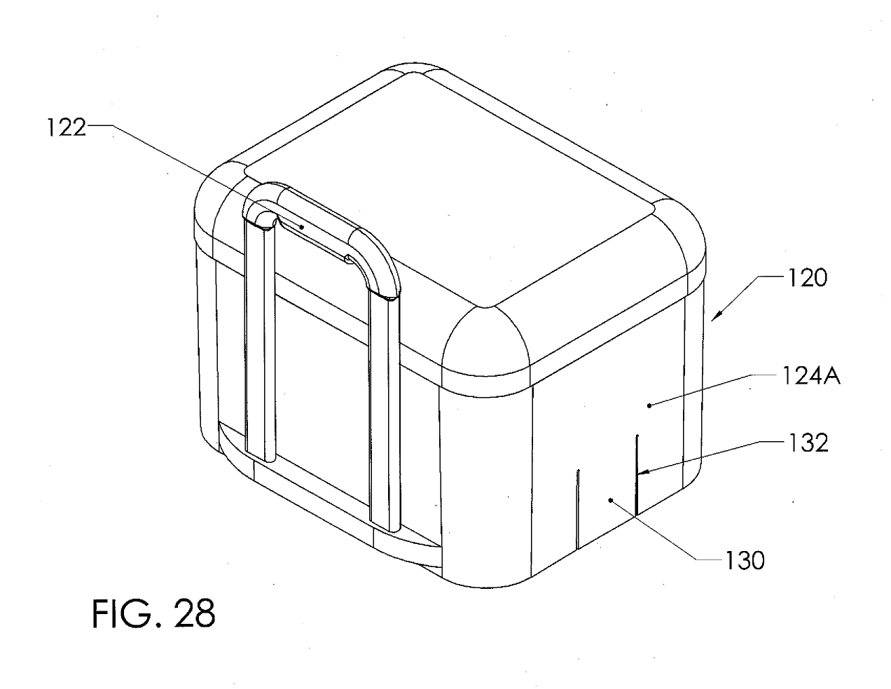

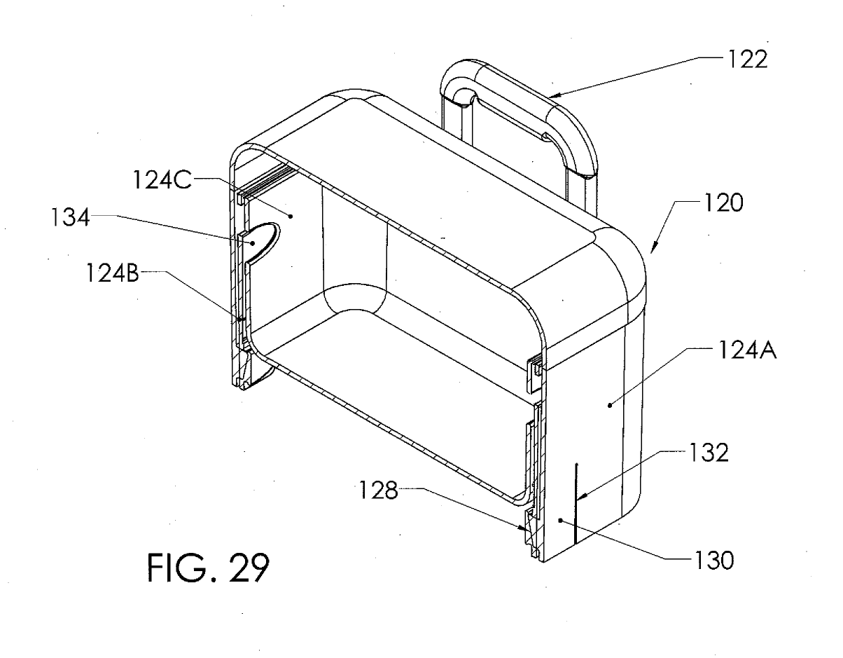

To expand the collapsible suitcase 120 starting from the collapsed configuration as shown in FIGS. 28 and 29, the outer most outer wall segment 124A is gripped and pulled upwardly. The semicircular lugs 128 ride upwardly along the exterior wall of the adjacent outer wall segment, then snap into the semicircular opening 134. The same operation is repeated for each of the outer wall segments until the collapsible suitcase 120 is in the expanded configuration.

To collapse the collapsible suitcase 120, the semicircular lugs 128 are pressed outwardly until the base of the lug 128 passes the lower edge of the semicircular opening 134. The outer wall segment is then pushed downwardly so that the resilient tab 130 and lug 128 cam outwardly and ride downwardly along the exterior of the adjacent outer wall segment until the outer wall segments align. This process is repeated for each of the outer wall segments until the collapsible storage container is then in the collapsed position.

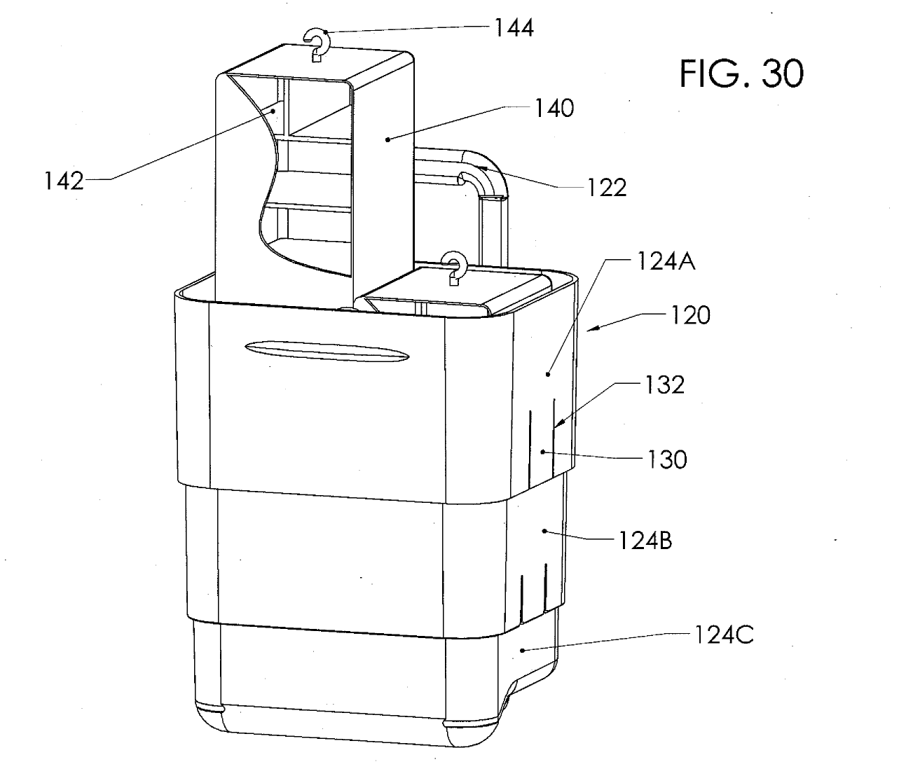

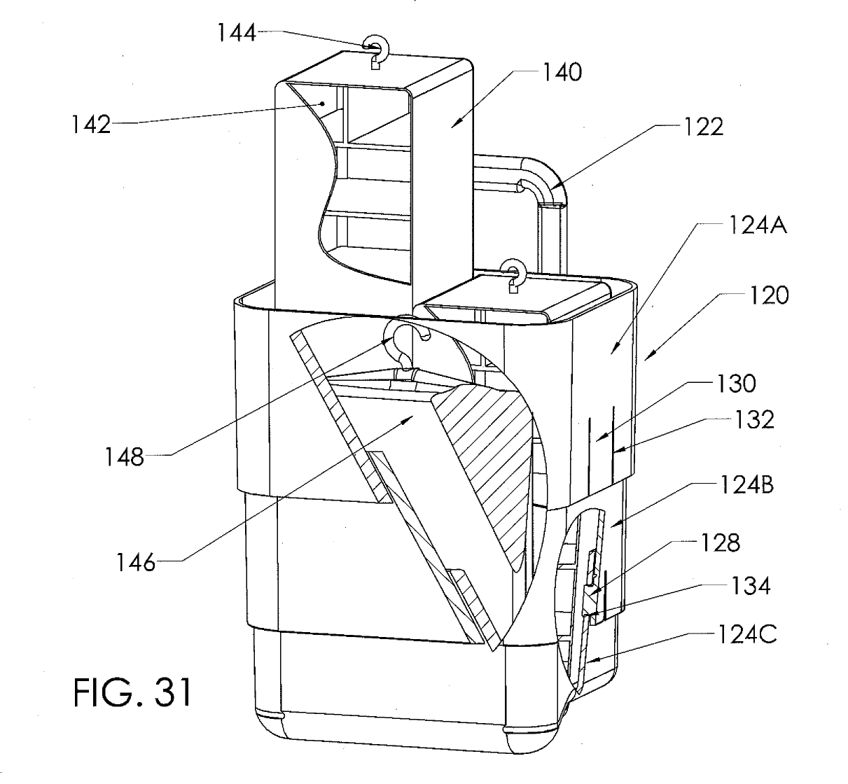

As illustrated in FIGS. 30 and 31, the collapsible suitcase 120 may be provided with a plurality of storage inserts to maximize the storage and organization of the contents of the collapsible suitcase. Such storage inserts may include compartmentalized insets 140 and garment hangers 146.

The compartmentalized inserts 140 are preferably of a height equal to the interior height of the collapsible suitcase in the expanded configuration. The compartmentalized inserts 140 are provided with side walls, top, bottom and back walls and an open front constituted of flexible material such as fabric and the like to facilitate collapse into a compact size. The interior of the compartmentalized inserts 140 are divided into a plurality of individual compartments 142 by suitably placed dividers. In this way, clothing and accessory items may be organized in individual compartments so they are easily seen and accessible to the user. For example, shoes, shirts, socks, underwear, etc. may be placed in individual compartments making the selection of the desired items easier. The compartmentalized inserts 140 may be provided with a hanging hook 144 on the top to allow the insert to be removed from the suitcase 120 and hung in a closet for easy access.

In addition to the compartmentalized inserts 140, the collapsible container may also be provided with garment hangers 146 to hang and keep from being crushed or wrinkled garments such suits, dresses, etc. The garment hangers 146 include suitable hangers 148 for the garments. The collapsible suitcase may be provided with a means for holding a hanging hook 148 which also allows the garments to be hung in a closet for easy access.

The collapsible container of the present invention provides for a collapsible container which is easily movable from a collapsed position having a reduced volume for storage and transport and an expanded position having dimensional rigidity and securely holding the contents of the container. As described above, the collapsible container of the present invention may be adapted for many different uses.

The collapsible container of the present invention has dimensional stability in the expanded position, a property which is of special importance when the container is used to store and transport heavier items such as when being used as a suitcase. In order to provide the dimensional stability, the outer wall segments are preferably constructed of a suitable material which provides for the dimensional stability while also allowing for the resiliency required for the releasable locking means. The material from which the outer wall segments may be constructed include a suitably dimensioned metal as well as suitable polymeric materials. Among the suitable polymeric materials are polyamides such as nylon, polyvinylchloride, polypropylene, etc. Preferably, the outer wall segments are a polyamide such as nylon.

The inner liner, particularly those used in collapsible containers used for food or beverage storage are preferably constructed of a food grade polymeric material such as silicon, polypropylene, etc. Preferably, in order to also provide for the capability of heating food or beverage in the container, the inner liner is constructed of a food grade silicon which will withstand the temperatures encountered in heating of the food or beverage contained in the container.

Although various preferred embodiments of the present invention have been described herein in detail, it will appreciated by those of skill in the art that variations may be made thereto without parting from the spirit of the invention or the scope of the appended claims.

I claim:

1. A rigid collapsible cooking container which is easily movable from a collapsed position having a reduced volume for compact portability, to an erect position having increased volume for fluid or solids storage and dimensional rigidity, without the use of thread fasteners such as UNC, UN, NPT, BSP, or any such thread requiring rotation to deploy into the erect position, forming a container comprising:
a plurality of rigid outer wall ring segments comprising an upper most rigid outer wall ring segment and adjacent upper rigid outer wall ring segments each having an upper and lower edge, and an upper and lower opening, capable of nesting one rigid outer wall ring segment within the other in a telescoping fashion;
a single lower most rigid outer wall ring segment having an upper opening, an upper edge capable of nesting within adjacent rigid upper outer wall ring segment, and a closed bottom;
said outer wall ring segments each having an outer wall turned edge configuration forming a protrusion configuration on said outer wall upper edges;
said outer wall ring segments, with the exception of said lower most outer wall ring segment, having outer wall groove configuration on said outer wall lower edges to interlock to said outer wall protrusion configurations in the erect position to form a dimensionally rigid erect container of fixed rigid outer wall ring segments;

2. A collapsible container according to claim 1 wherein said single lower most outer wall ring segment closed bottom is provided with an anchor point in the form of an opening whose surface area is smaller than the surface area circumscribed by the lower edge.

3. A collapsible container according to claim 2 wherein a collapsible, water-tight, inner liner is provided comprising
a collapsible design commonly known to industry relating to collapsible liners;
said collapsible inner liner is thermally insulating;
an addition of an upper lip on said collapsible inner liner containing a groove that is remove-ably fasten-able to the upper edge of the upper most rigid outer wall segment and whose size is consistent with the upper most rigid outer wall segment upper edge protrusion configuration to permit fastening thereto;
an additional closed bottom provided with an anchor point in the form of an opening whose shape is identical to that of said opening in said lower most rigid outer wall ring segment closed bottom, but whose diameter is slightly smaller to accommodate a sealing means, and whose opening has a torus ring integrated around the bottom opening circumference for the purpose of providing an o-ring seal when assembled to the sealing means;
said torus ring whose thickness is slightly greater than that of the closed bottom of the lower most rigid outer wall ring segment.

4. A collapsible container according to claim 3 wherein a flange pair is provided to fix said flexible thermally insulating, water-tight, inner liner anchor point to said lower most rigid outer wall ring segment bottom anchor point comprising
a male flange and mating female flange that can be securely fastened one to the other by means common to industry such as threading, bolting to form a flange pair, while sandwiching said rigid outer wall ring segment bottom anchor point and said flexible inner liner bottom torus o-ring anchor;
said flange pair equipped with o-ring grooves on each flange mating side whose diameter, circumference and shape permits sandwiching of said collapsible inner liner torus ring such that mating the flanges provides a water-tight seal consistent with industry standards common to o-ring compression seals, such as with 3-A standard and tri-clover standards;
said flange pair whose upper and lower halves simultaneously provide compression to said o-ring seal as well as to sandwich said rigid outer wall ring segment bottom thereby securely fastening said collapsible thermally insulating liner and said rigid outer wall ring segment bottom portion between said flange pair.

5. A collapsible container according to claim 4 in which said flange pair is thermally conductive to permit conductive heat transfer across the flange pair.

6. A collapsible container according to claim 4 in which said flange pair is made of an austenitic alloy, copper, brass or a similar metallic thermally conductive alloy.

7. A collapsible container according to claim 6 in which said flange pair is made to American Society of Mechanical Engineers Bio Processing Engineering (ASME BPE) standards, or the like, to ensure food safety.

8. A collapsible container according to claim 4 in which said flange pair is made of ceramic or similar non-metallic thermally conductive material.

9. A collapsible container according to claim 3 in which said liner is made of high temperature resistant thermally insulating silicone, or polymer sheeting to withstand temperatures of at least 100 C.

10. A collapsible container according to claim 8 in which said liner is food grade FDA approved.

11. A collapsible container according to claim 1 wherein the outer wall segments are metallic;

12. A collapsible container according to claim 1 wherein the outer wall segments are composite;

13. A collapsible container according to claim 1 wherein the outer wall segments are polymeric.
